(19) United States
(12) Patent Application Publication
(10) Pub. No.: US 2025/0346115 A1
(43) Pub. Date: Nov. 13, 2025

(54) VEHICLE SWITCH DEVICE

(71) Applicants: TOYOTA JIDOSHA KABUSHIKI KAISHA, Toyota-shi (JP); KABUSHIKI KAISHA TOKAI RIKA DENKI SEISAKUSHO, Niwa-gun (JP); DaikyoNishikawa Corporation, Higashihiroshima-shi (JP)

(72) Inventors: Yoshiyuki MURAMATSU, Toyota-shi (JP); Kei YAMAMOTO, Toyota-shi (JP); Junichi FUKUZAKI, Toyota-shi (JP); Kazuo DODOMEKI, Niwa-gun (JP); Masayoshi AMANO, Niwa-gun (JP); Hideki YAMASHITA, Kure-shi (JP); Yoshihisa MANTOKU, Hiroshima-shi (JP); Shigeki YAMAMOTO, Hiroshima-shi (JP); Hiroshi ARITA, Hiroshima-shi (JP); Masahiro HORINO, Higashihiroshima-shi (JP); Yuji KAWAMOTO, Hiroshima-shi (JP)

(73) Assignees: TOYOTA JIDOSHA KABUSHIKI KAISHA, Toyota-shi (JP); KABUSHIKI KAISHA TOKAI RIKA DENKI SEISAKUSHO, Niwa-gun (JP); DaikyoNishikawa Corporation, Higashihiroshima-shi (JP)

(21) Appl. No.: 19/175,188

(22) Filed: Apr. 10, 2025

(30) Foreign Application Priority Data
May 10, 2024 (JP) 2024-077433

(51) Int. Cl. B60K 35/10; B32B 27/32; B32B 27/36; H01H 13/14

(52) U.S. Cl. CPC B60K 35/10; H01H 13/14; B32B 27/32; B32B 27/36; B32B 2307/7376; B32B 2457/00; B60K 2360/128

(57) ABSTRACT

For a light-transmitting switch in which a tip portion of a switch movable knob is inserted in an opening provided in a partition panel of a base material and a cushion material is disposed between an outermost cover material and the partition panel, a film is interposed between the cushion material and the partition panel and between the cushion material and the tip surface of the switch movable knob. As a result, even when the position of the switch movable knob relative to the base material is deviated from an appropriate position, the film supports the cushion material, so that the surface shape of the cushion material can be made flat. Therefore, it is possible to restrain occurrence of unevenness on the surface of the outermost cover material, and restrain deterioration in design of a vehicle cabin.

### CROSS-REFERENCE TO RELATED APPLICATION

This application claims priority to Japanese Patent Application No. 2024-077433 filed on May 10, 2024, incorporated herein by reference in its entirety.

### BACKGROUND

### 1. Technical Field

The present disclosure relates to a vehicle switch device. Particularly, the present disclosure relates to an improvement in the internal structure of a vehicle switch device.

### 2. Description of Related Art

Conventionally, a plurality of switches for operating in-vehicle devices such as an air conditioner (car air conditioner) and activating various driving assistance functions is arranged in an instrument panel, a center console, etc. inside a vehicle cabin of a vehicle.

Furthermore, Japanese Unexamined Patent Application Publication No. 2020-24832 (JP 2020-24832 A) discloses a light-transmitting switch that is incorporated with a light source and configured such that when the light source emits light, a figure (hereinafter, sometimes referred to as a symbol) corresponding to the type of a switch is illuminated (the shape of a symbol emerges) on the instrument panel.

In a specific configuration of the light-transmitting switch disclosed in JP 2020-24832 A, a light source and a switch member having translucency (light transmission) are disposed inside an opening formed in a base material of an instrument panel, and a cushion layer is provided on the surfaces of the base material and the switch member. An area of the cushion layer that overlaps with the switch member is made of silicone resin having translucency, and a decorative layer is provided on the surface of the silicone resin. A peel-off portion that matches the shape of a symbol is formed in the decorative layer. The entire surface of the cushion layer is covered with a translucent outermost cover. As a result, when the light source emits light, the light from the light source passes through the switch member, the silicone resin of the cushion layer, the peel-off portion of the decorative layer, and the outermost cover, and the symbol shines (the shape of the symbol emerges) on the instrument panel, which allows an occupant to recognize (visually recognize) the type and position of the switch.

### SUMMARY

However, in the configuration disclosed in JP 2020-24832 A, when variation occurs in the position (the position in a direction along a pushing direction of the light-transmitting switch) of a switch movable portion (a movable portion configured by the switch member and the cushion layer) relative to the base material due to a manufacturing error, an assembly error or the like of the base material or the switch member, there has been a possibility that the variation causes unevenness to occur on the surface of the instrument panel, and the unevenness of the surface of the instrument panel leads to a deterioration in the design of the vehicle cabin.

The present disclosure has been made in view of the problem, and has an object to provide a vehicle switch device that can improve the design of the inside of a vehicle cabin.

A solution of the present disclosure for achieving the foregoing object presupposes a vehicle switch device including a base material, a switch member that is movable by receiving push-in operation force, a cushion material having translucency and elasticity that is disposed on a surface side of the switch member, and an outermost cover material that is disposed across a surface side of the base material and a surface side of the cushion material. In the vehicle switch device, a film is interposed in at least one of gaps defined among the switch member, the cushion material, and the outermost cover material.

With this specific matter, even when the position of the switch member relative to the base material (the position in a direction along an acting direction of push-in operation force) is deviated from an appropriate position due to a manufacturing error, an assembly error or the like of the base material or the switch member, the film supports the cushion material (an action and an effect when the film is interposed between the switch member and the cushion material) or the film contributes to flattening of the surface of the cushion material (an action and an effect when the film is interposed between the outermost cover material and the cushion material), whereby it is possible to flatten the surface shape of the cushion material. Therefore, occurrence of unevenness on the surface of the outermost cover material disposed on the surface side of the cushion material can be restrained, and deterioration in the design of the inside of the vehicle cabin can be restrained.

Furthermore, as a specific configuration of the vehicle switch device, the base material includes a plate material disposed at a position set back from the outermost cover material, the plate material being provided with an opening through which a tip portion of the switch member is inserted, the cushion material is disposed between the plate material and the outermost cover material, and the film is interposed between the plate material and the cushion material, the film being in contact with an entire surface of the cushion material that faces the plate material.

Since the film is in contact with the entire surface of the cushion material which faces the plate material, the film supports the entire cushion material, which makes it possible to fully exert an effect of flattening the shape of the surface of the cushion material, so that it is possible to reliably restrain occurrence of unevenness on the surface of the outermost cover material.

Specifically, the film is made of resin, and has a thickness dimension of 30 μm to 100 μm.

When the thickness dimension of the film is excessively small, it is impossible to fully exert the effect of flattening the surface shape of the cushion material, and when the thickness dimension is excessively large, the resistance to the push-in operation of the vehicle switch device increases, which causes deterioration in operability. In view of this point, the present solution sets the thickness dimension of the film to the above values in order to optimize the thickness dimension.

As physical properties of a material constituting the film, the tensile strength in a machine direction is set in a range from 200 MPa to 240 MPa, the tensile strength in a direction perpendicular to the machine direction is set in a range from 220 MPa to 260 MPa, the tensile elongation in the machine direction is set in a range from 190% to 230%, the tensile elongation in the direction perpendicular to the machine direction is set in a range from 130% to 160%, an Fs value in the machine direction is set in a range from 105 MPa to 130 MPa, an Fs value in the direction perpendicular to the machine direction is set in a range from 100 MPa to 120 MPa, the tensile elasticity in the machine direction is set in a range from 3.5 GPa to 4.2 GPa, and the tensile elasticity in the direction perpendicular to the machine direction is set in a range from 3.8 GPa to 4.5 GPa.

As a result, it is possible to implement a film that stably exerts the above-mentioned effects over a long period of time.

In the present disclosure, the film is interposed in at least one of gaps defined among the switch member, the cushion material, and the outermost cover material that constitute the vehicle switch device. Therefore, even when the position of the switch member relative to the base material is deviated from an appropriate position, the film supports the cushion material and contributes to flattening of the surface of the cushion material, which makes it possible to flatten the surface shape of the cushion material. As a result, it is possible to restrain occurrence of unevenness on the surface of the outermost cover material disposed on the surface side of the cushion material, and restrain deterioration in the design of the vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram showing the light-up state of each light-transmitting switch incorporated in an instrument panel according to an embodiment, and also is a front view of the instrument panel;

FIG. 1B is a diagram showing the light-up state of each light-transmitting switch incorporated in the instrument panel according to the embodiment, and also is an enlarged view showing light-up states of light-transmitting switches of an air-conditioning system;

FIG. 1C is a diagram showing the light-up state of each light-transmitting switch incorporated in the instrument panel according to the embodiment, and also is an enlarged view showing light-up states of light-transmitting switches of an audio system;

FIG. 1D is a diagram showing the light-up state of each light-transmitting switch incorporated in the instrument panel according to the embodiment, where FIG. 1D is an enlarged view showing light-up states of a seat memory switch;

FIG. 1E is a diagram showing the light-up state of each light-transmitting switch incorporated in the instrument panel according to the embodiment, and also is an enlarged view showing light-up states of a parking assist switch and a panoramic view monitor switch;

FIG. 2 is a sectional view of the light-transmitting switch taken along line II-II in FIG. 1A, FIG. 1B, FIG. 1C, FIG. 1D, and FIG. 1E;

FIG. 3 is a block diagram showing a schematic configuration of a control system for the light-transmitting switches according to the embodiment;

FIG. 4A is a diagram equivalent to FIG. 2 in a case where a reference position of a switch member is shifted to a front surface side of the instrument panel, and also no film is provided;

FIG. 4B is a diagram equivalent to FIG. 2 in a case where the reference position of the switch member is shifted toward the front surface side of the instrument panel, and also a film is provided;

FIG. 5A is a diagram equivalent to FIG. 2 in a case where the reference position of the switch member is shifted toward a back side of the instrument panel, and also no film is provided;

FIG. 5B is a diagram equivalent to FIG. 2 in a case where the reference position of the switch member is shifted toward the back side of the instrument panel, and also a film is provided; and

FIG. 6 is a diagram showing a result of an experiment to compare the case where a film is provided and the case where no film is provided.

### DETAILED DESCRIPTION OF EMBODIMENTS

An embodiment of the present disclosure will be described hereinafter with reference to the drawings. The present embodiment describes a case where the present disclosure is applied to a configuration in which a plurality of light-transmitting switches (a vehicle switch device in the present disclosure) is incorporated in an instrument panel inside a vehicle cabin.

### Arrangement Style of Light-transmitting Switches

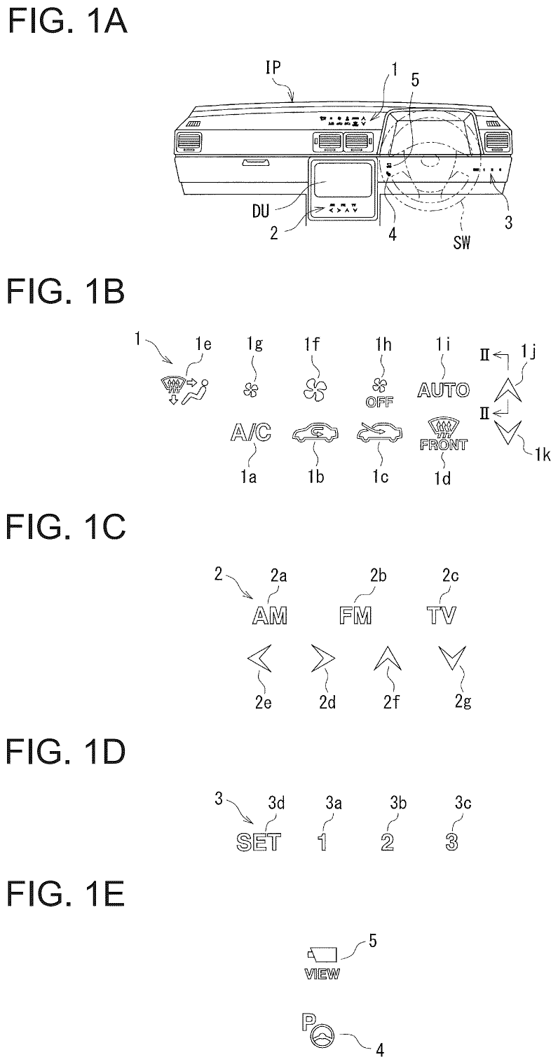

FIG. 1A is a front view of an instrument panel IP in which light-transmitting switches 1, 2, 3, 4, and 5 according to the present embodiment are incorporated, and also shows a light-up state of each of the light-transmitting switches 1 to 5. FIG. 1B is an enlarged view showing the light-up state of a light-transmitting switch 1 (la to 1k) for an air-conditioning system, FIG. 1C is an enlarged view showing the light-up state of a light-transmitting switch 2 (2a to 2g) for an audio system, FIG. 1D is an enlarged view showing the light-up state of a seat memory switch 3 (3a to 3d), and FIG. 1E is an enlarged view showing the light-up states of a parking assist switch 4 and a panoramic view monitor switch 5.

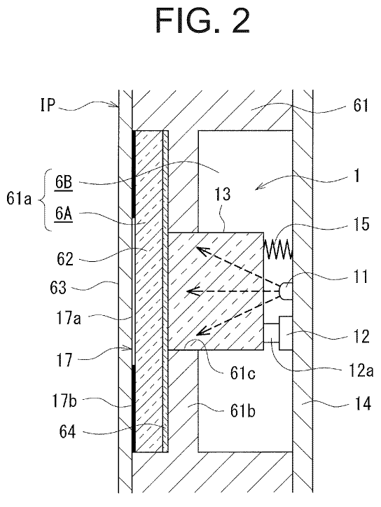

As shown in FIG. 1A, the instrument panel IP according to the present embodiment has the light-transmitting switch 1 (la to 1k) for the air-conditioning system and the light-transmitting switch 2 (2a to 2g) for the audio system, the light-transmitting switches 1 and 2 being arranged at a center portion (a center portion in a vehicle width direction) of the instrument panel IP (incorporated in the instrument panel IP). Furthermore, the seat memory switch 3 (3a to 3d) is arranged (incorporated in the instrument panel IP) as a light-transmitting switch at a position that is closer to a driver's seat in the instrument panel IP and is on the outside of a steering wheel SW in the vehicle width direction (indicated by an imaginary line in FIG. 1A). Furthermore, the parking assist switch 4 and the panoramic view monitor switch 5 are arranged (incorporated in the instrument panel IP) at positions that are closer to the driver's seat in the instrument panel IP and are on the inside of the steering wheel SW in the vehicle width direction. Since these light-transmitting switches 1 to 5 are incorporated in the instrument panel IP, each of the light-transmitting switches 1 to 5 is operated by pushing an outermost cover material 63 (see FIG. 2) of the instrument panel IP corresponding to each of the light-transmitting switches 1 to 5 as described later. Note that the arrangement style of these light-transmitting switches 1 to 5 is not limited to that shown in FIG. 1A. Furthermore, the types and number of the light-transmitting switches 1 to 5 are not limited to those shown in FIG. 1A.

The light-transmitting switch 1 for the air-conditioning system includes an air-conditioning switch (compressor operating switch) la, an interior air recirculation mode switch 1b, an outside air introduction mode switch 1c, a front defroster switch 1d, an air blowout mode switch 1e, an airflow increasing switch 1f, an airflow decreasing switch 1g, an OFF switch 1h, an auto switch 1i, a set temperature UP switch 1j, and a set temperature DOWN switch 1k. As shown in FIG. 1B, when each of the light-transmitting switches 1a to 1k is set to a light-up state, an individual symbol thereof lights up (the shape of the symbol emerges on the instrument panel IP). A configuration for causing the shape of the symbol to emerge on the instrument panel IP will be described later.

The light-transmitting switch 2 for the audio system includes an AM radio switch 2a, an FM radio switch 2b, and a TV switch 2c as source selection switches. Furthermore, the light-transmitting switch 2 for the audio system also includes a channel feed switch 2d, a channel return switch 2e, a volume up switch 2f, and a volume down switch 2g. As shown in FIG. 1C, when each of these light-transmitting switches 2a to 2g is set to a light-up state, an individual symbol thereof lights up.

The seat memory switch 3 is a switch that moves a seat (driver's seat) to a pre-stored seat position and is used when the vehicle is in a stop state. The seat memory in the present embodiment includes three position switches 3a, 3b, and 3c, and a set switch 3d for setting (registering) a position. As shown in FIG. 1D, when each of these light-transmitting switches 3a to 3d is set to a light-up state, an individual symbol thereof also lights up.

The parking assist switch 4 is a switch for activating a parking assist (automatic parking) function installed in the vehicle. This parking assist is a function of causing the vehicle to park at a designated parking area by autonomous driving. As shown in FIG. 1E, when the parking assist switch 4 is set to a light-up state, a symbol thereof also lights up.

The panoramic view monitor switch 5 is a switch for activating a panoramic view monitor function installed in the vehicle. The panoramic view monitor is a function of displaying, on a display device DU in the vehicle cabin, an image that enables the surroundings of the vehicle to be recognized in terms of a viewpoint above the vehicle by combining a plurality of images from external cameras (not shown) of the vehicle, and the panoramic view monitor is provided to assist driving for the driver. As shown in FIG. 1E, when the panoramic view monitor switch 5 is set to a light-up state, a symbol thereof also lights up.

### Configuration of Light-Transmitting Switch

Next, the configurations of the light-transmitting switches 1 to 5 will be described. Since the respective configurations of the light-transmitting switches 1 to 5 are all substantially the same, the configuration of one light-transmitting switch 1 will be described as an example.

FIG. 2 is a sectional view of the light-transmitting switch 1 taken along line II-II in FIG. 1B. As shown in FIG. 2, the light-transmitting switch 1 is disposed so as to be embedded inside the instrument panel IP. Specifically, the basic structure of the instrument panel IP includes a non-translucent base material 61 made of resin, a cushion material 62, and a translucent (light-transmitting) outermost cover material 63 disposed on the front surface side of the base material 61 and the cushion material 62.

The base material 61 is made of resin such as polypropylene (PP) or polyethylene terephthalate (PET). At the position of the light-transmitting switch 1 in the base material 61, a switch movable portion accommodating space 61a that opens to a front surface side (left side in FIG. 2) of the instrument panel IP and a back surface side (right side in FIG. 2) of the instrument panel IP are provided at a position in the base material 61 where the light-transmitting switch 1 is disposed. This switch movable portion accommodating space 61a is provided with a partition panel (a plate material in the present disclosure) 61b that partitions the switch movable portion accommodating space 61a into a first space 6A and a second space 6B, the first space 6A being a space located on the front surface side of the instrument panel IP and the second space 6B being a space located on the back side of the instrument panel IP. An opening 61c is provided at a center portion of the partition panel 61b. The opening shape of the opening 61c (the shape of the opening when viewed in a direction perpendicular to the surface of the instrument panel IP) is circular or polygonal.

The second space 6B accommodates a light source 11, for example an alternate switch 12. Furthermore, a tip portion of a switch movable knob (switch member) 13 is inserted into the opening 61c, and a rear end portion of the switch movable knob 13 (a portion that is not inserted into the opening 61c) is located in the second space 6B.

The light source 11 is attached onto a circuit board 14 that is attached to the back surface side of the base material 61 (the back side of the instrument panel IP), and it is configured by, for example, a light emitting diode (LED). The attachment position of the light source 11 on the circuit board 14 is a position facing the back surface of the switch movable knob 13.

The switch 12 is attached onto the circuit board 14. The switch 12 has a push-in member 12a that is pushed in by receiving push-in operation force from the outermost cover material 63 side through the switch movable knob 13, and when the light-transmitting switch 1 is not operated, the tip surface of the push-in member 12a abuts against the back surface of the switch movable knob 13 or faces the back surface of the switch movable knob 13 through a minute gap. When the light-transmitting switch is operated, the push-in member 12a is pushed in, and as a result, the operation of the in-vehicle device (the air conditioner, the audio system or the like) is switched on or off or the driving assistance function (the parking assist function, the panoramic view monitor function, etc.) is started or the like in response to the operation of the light-transmitting switch.

The switch movable knob 13 is cubic and made of translucent resin, and biasing force directing toward the outermost cover material 63 of the instrument panel IP is applied to the switch movable knob 13 by a spring 15 disposed between the switch movable knob 13 and the circuit board 14. Note that the biasing force of the spring 15 is preset such that in a state where no push-in operation force is applied, the tip surface of the switch movable knob 13 is flush with the surface of the partition panel 61b and thus the surface of the outermost cover material 63 is flat. Furthermore, as described later, when there occurs a manufacturing error, an assembly error or the like of the base material 61 or the switch movable knob 13 or the like, the position of the switch movable knob 13 (the position in the direction along the push-in direction) relative to the base material 61 may shift from an appropriate position.

The cushion material 62 is accommodated in the first space 6A. The cushion material 62 is made of a material having translucency and elasticity such as silicone resin. As an example of the shape of the cushion material 62 (the shape when viewed in a direction perpendicular to the surface of the instrument panel IP), it approximately matches the shape of the first space 6A. Furthermore, as an example of the thickness dimension of the cushion material 62, it is set to be shorter than the depth dimension of the first space 6A (the dimension in a direction along the push-in direction) by the sum of the thickness dimension of a film 64 described later and the thickness dimension of the decorative layer 17.

The decorative layer 17 is provided on the rear surface side of the outermost cover material 63 and in an area facing the cushion material 62. The decorative layer 17 has a peel-off portion 17a that is formed to match the shape of the symbol described above. Specifically, a coating film 17b is formed on the back surface of the outermost cover material 63 by painting, and a part of the coating film 17b is peeled off by a laser or the like, whereby a translucent peel-off portion 17a is formed to have a shape matching the shape of the symbol is formed. The decorative layer 17 is formed by the peel-off portion 17a and the coating film 17b, whereby the peel-off portion 17a forms a translucent region (a translucent region for transmitting light from the light source 11 through the surface of the instrument panel IP into the vehicle cabin).

The outermost cover material 63 is disposed so as to cover the entire surfaces of the base material 61, the cushion material 62, and the decorative layer 17, and is entirely bonded to the base material 61 with the terminal thereof being fixed in a state of being wrapped around the back side of the base material 61. Note that the outermost cover material 63 may be entirely translucent, or may be translucent only in an area facing each of the light-transmitting switches 1 to 5 (an area facing the cushion material 62).

A feature of the present embodiment resides in that the film 64 is interposed between the cushion material 62 and the partition panel 61b and between the cushion material 62 and the tip surface of the switch movable knob 13. This film 64 is made of a translucent resin (such as polypropylene or polyethylene terephthalate). There is no particular limitation to the material constituting the film 64.

The film 64 is provided so that the shape of the surface of the cushion material 62 can be made flat by supporting the cushion material 62 even when the position of the switch movable knob 13 relative to the base material 61 (the position in a direction along the push-in direction) is deviated from an appropriate position due to a manufacturing error, an assembly error or the like of the base material 61 or the switch movable knob 13.

The film 64 is in contact with the entire back surface of the cushion material 62. In other words, the shape of the film 64 (the shape when viewed in a direction perpendicular to the surface of the instrument panel IP) approximately matches the shape of the cushion material 62 (when viewed in the same direction).

The thickness dimension of the film 64 adopted in the present embodiment is set in a range from 30 μm to 100 μm. The reason for this is as follows. When the thickness dimension of the film 64 is excessively small, it is not possible to fully achieve the effect of flattening the surface shape of the cushion material 62, but when the thickness dimension is excessively large, the resistance to the push-in operation of the light-transmitting switch 1 increases, resulting in deterioration in operability. In light of this, the thickness dimension of the film 64 is specified to be optimized based on experiments or simulations, sensory evaluation, etc.

In the present embodiment, the thickness dimension of the film 64 is set in the range from 30 μm to 100 μm as described above, but preferably, it may be set in a range from 40 μm to 80 μm, or more preferably, in a range from 50 μm to 60 μm.

Furthermore, as physical properties of the constituent material of the film 64, the tensile strength in a machine direction is set in a range from 200 MPa to 240 MPa, the tensile strength in a direction perpendicular to the machine direction is set in a range from 220 MPa to 260 MPa, the tensile elongation in the machine direction is set in a range from 190% to 230%, the tensile elongation in the direction perpendicular to the machine direction is set in a range from 130% to 160%, the Fs value in the machine direction is set in a range from 105 MPa to 130 MPa, the Fs value in the direction perpendicular to the machine direction is set in a range from 100 MPa to 120 MPa, the tensile elasticity in the machine direction is set in a range from 3.5 GPa to 4.2 GPa, and the tensile elasticity in the direction perpendicular to the machine direction is set in a range from 3.8 GPa to 4.5 GPa. This has been specified by experiments or simulations in order to implement a film 64 that stably exerts the above-mentioned effects (the effect of flattening the surface shape of the cushion material 62 and the effect of restraining deterioration in operability are made compatible with each other) over a long period of time.

In the present embodiment, the tensile strength in the machine direction of the film 64 is set in the range from 200 MPa to 240 MPa. However, it may be preferably set in a range from 200 MPa to 220 MPa, and more preferably it may be set in a range from 200 MPa to 210 MPa. Furthermore, the tensile strength in the direction perpendicular to the machine direction is set in the range from 220 MPa to 260 MPa. However, it may be preferably set in a range from 220 MPa to 240 MPa, and more preferably, it may be set in a range from 220 MPa to 230 MPa. The tensile elongation in the machine direction is set in the range from 190% to 230%. However, it may be preferably set in a range from 190% to 210%, and more preferably, it may be set in a range from 190% to 200%. The tensile elongation in the direction perpendicular to the machine direction is set in the range from 130% to 160%. However, it may be preferably set in a range from 130% to 150%, and more preferably, it may be set in a range from 130% to 140%. The Fs value in the machine direction is set in the range from 105 MPa to 130 MPa. However, it may be preferably set in a range from 105 MPa to 120 MPa, and more preferably, it may be set in a range from 105 MPa to 110 MPa. The Fs value in the direction perpendicular to the machine direction is set in the range from 100 MPa to 120 MPa. However, it may be preferably set in a range from 100 MPa to 110 MPa, and more preferably, it may be set in a range from 100 MPa to 105 MPa. The tensile elasticity in the machine direction is set in the range from 3.5 GPa to 4.2 GPa. However, it may be preferably set in a range from 3.5 GPa to 3.8 GPa, and more preferably, it may be set in a range from 3.5 GPa to 3.6 GPa. The tensile elasticity in the direction perpendicular to the machine direction is set in the range from 3.8 GPa to 4.5 GPa. However, it may be preferably set in a range from 3.8 GPa to 4.2 GPa, and more preferably, it may be set in a range from 3.8 GPa to 4.0 GPa.

The light-transmitting switch 1 is configured as described above, so that when the light source 11 is turned on, the light of the light source 11 passes through the switch movable knob 13, the film 64, and the cushion material 62 and reaches the decorative layer 17. In the decorative layer 17, the transmitted light is blocked by the coating film 17b, and passes through the peel-off portion 17a. As a result, the light transmitted through the peel-off portion 17a (the light transmitted in the shape of a symbol) is also transmitted through the outermost cover material 63, and the symbol lights up on the instrument panel IP (the shape of the symbol emerges), which allows an occupant to recognize (visually recognize) the type and position of the light-transmitting switch 1. For this reason, at the position where the light-transmitting switch 1 is disposed, not only the light source 11, the switch 12, the switch movable knob 13, the circuit board 14, and the spring 15, but also the film 64, the cushion material 62, the decorative layer 17, the base material 61 (particularly the partition panel 61b), and a part of the outermost cover material 63 (particularly the area facing the cushion material 62) are components of the light-transmitting switch 1.

### Overall Configuration of Control System

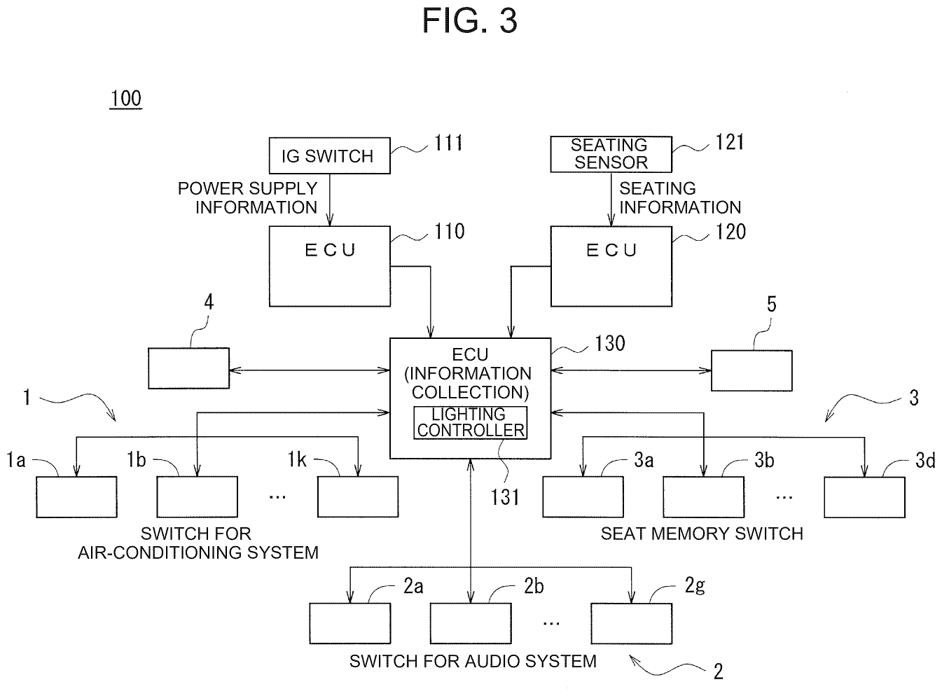

Next, a control system for controlling a light-up state and a light-off state of each of the light-transmitting switches 1 to 5 will be described. FIG. 3 is a block diagram showing the overall configuration of a control system 100 for the light-transmitting switches 1 to 5 according to the present embodiment.

As shown in FIG. 3, the control system 100 is configured to include a first ECU 110 that is connected to an IG switch 111 to acquire power supply information, a second ECU 120 that is connected to a seating sensor 121 provided in the driver's seat to acquire seating information, a third ECU 130 that collects information pieces from these ECUs 110, 120 to control the light-up state and the light-off state of each of the light-transmitting switches 1 to 5, and the light-transmitting switches 1 to 5. Each of the ECUs 110, 120, 130 includes, for example, a processor such as CPU, ROM that stores a control program, RAM that temporarily stores data, an input/output port, etc.

The ECUs 110, 120, 130 and the light-transmitting switches 1 to 5 are connected to one another via a vehicle network signal line (controller area network (CAN) signal line) and a clock extension peripheral interface (CXPI) signal line to enable transmission and reception of information among them. Note that the vehicle network for enabling the transmission and reception of information is not limited to this style, and it is also possible to adopt Ethernet, FLEXRAY, local interconnect network (LIN), etc.

When a driver performs a turn-on operation or turn-off operation on the IG switch 111, the first ECU 110 receives information (power supply information) from the IG switch 111. Furthermore, the first ECU 110 transmits the information received from the IG switch 111 (ON/OFF information of the IG switch 111) to the third ECU 130.

When the driver sits on the driver's seat, the second ECU 120 receives information on the driver's seating (seating information) from the seating sensor 121. The second ECU 120 also transmits the information received from the seating sensor 121 to the third ECU 130.

The third ECU 130 receives the information from the first ECU 110 and the second ECU 120 and switches each of the light-transmitting switches 1 to 5 between the light-up state and the light-off state.

Specifically, the third ECU 130 includes a lighting controller 131 as a functional unit implemented by the control program.

When the lighting controller 131 receives seating information (information indicating that the driver has been seated in the driver's seat) from the second ECU 120 as control for setting each of the light-transmitting switches 1 to 5 to the light-up state, the lighting controller 131 transmits lighting command information to the seat memory switch 3 (3a to 3d), which causes the seat memory switch 3 (3a to 3d) to light up. The seat memory switch 3 (3a to 3d) may continue the light-up state until the IG switch 111 is turned off, or may be set to the light-off state when the state that the seat memory switch 3 (3a to 3d) is not operated continues for a predetermined period of time.

Furthermore, when the lighting controller 131 receives ON information (information indicating that the IG switch 111 has been turned on) from the first ECU 110 as control for setting each of the light-transmitting switches 1, 2, 4 and 5 to the light-up state, the lighting controller 131 transmits lighting command information to each of the light-transmitting switch 1 for the air-conditioning system, the light-transmitting switch 2 for the audio system, the parking assist switch 4, and the panoramic view monitor switch 5. As a result, the light-transmitting switches 1, 2, 4, and 5 is turned on. Note that at this time, the seat memory switch 3 may also be turned on at the same time. FIG. 1A is a front view of the instrument panel IP in this case. The light-up state of each of the light-transmitting switches 1 to 5 may continue until the IG switch 111 is turned off, or the light-transmitting switches 1 to 5 on which the operation has not been performed for a predetermined time may light out. In this case, it is unnecessary that all the light-transmitting switches 1 to 5 are caused to be lighted off, and the light-transmitting switches that are required to light up constantly among the light-transmitting switches 1 to 5 may be kept in the light-up state. An example of the light-transmitting switch that is required to light up constantly in this case is a front defroster switch 1d. Furthermore, when a light-transmitting switch is used as a switch for operating an emergency flashing indicator light (a so-called hazard lamp), this light-transmitting switch (a light-transmitting switch for operating the emergency flashing indicator light) is also a light-transmitting switch that is required to light up constantly.

As described above, when each of the light-transmitting switches 1 to 5 is turned off, it is difficult for the occupant to visually recognize the position of each of the light-transmitting switches 1 to 5. Therefore, each of the light-transmitting switches 1 to 5 may be provided with a built-in proximity detection member for detecting the approach or contact of an occupant's hand (finger). A well-known hover sensor can be used as this proximity detection member. By receiving a signal from the proximity detection member of each of the light-transmitting switches 1 to 5, the lighting controller 131 determines whether the occupant's hand has approached or contacted any of the light-transmitting switches 1 to 5, and if the hand has approached or contacted a light-transmitting switch, the lighting controller 131 transmits lighting command information to the light-transmitting switch. As a result, the light-transmitting switch that has received this lighting command information lights up.

### Effect of Embodiment

As described above, in the present embodiment, even when the position of the switch movable knob 13 relative to the base material 61 is deviated from the appropriate position due to a manufacturing error, an assembly error or the like of the base material 61 or the switch movable knob 13, the film 64 supports the cushion material 62, whereby it is possible to flatten the surface shape of the cushion material 62.

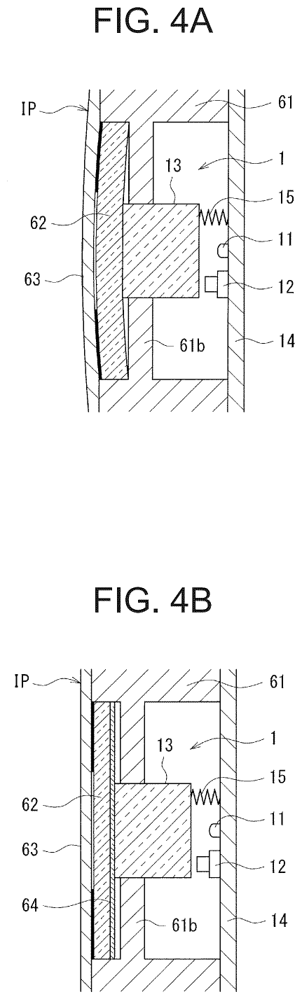

FIG. 4A, FIG. 4B show a case where a reference position of the switch movable knob 13 (the position of the switch movable knob 13 in a state where no push-in force is applied to the switch movable knob 13) is deviated toward the front surface side of the instrument panel IP, where FIG. 4A is a diagram equivalent to FIG. 2 when no film is provided, and FIG. 4B is a diagram equivalent to FIG. 2 when the film 64 is provided. When no film is provided, the center portion of the cushion material 62 is pressed toward the front surface side of the instrument panel IP by the switch movable knob 13, so that an outer edge portion of the cushion material 62 sags toward the partition panel 61b, which makes a part of the outermost cover material 63 convex in shape. In contrast, when the film 64 is provided, the film 64 supports the outer edge portion of the cushion material 62, which makes it possible to restrain the outer edge portion from sagging toward the partition panel 61b. Therefore, the shape of the surface of the cushion material 62 can be flatten, so that it is possible to restrain unevenness from occurring on the surface of the outermost cover material 63.

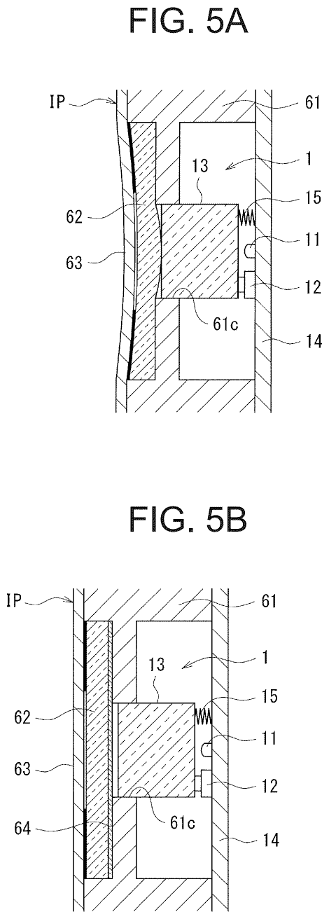

FIG. 5A, FIG. 5B show a case where the reference position of the switch movable knob 13 is shifted toward the back side of the instrument panel IP, where FIG. 5A is a diagram equivalent to FIG. 2 when no film is provided, and FIG. 5B is a diagram equivalent to FIG. 2 when the film 64 is provided. When no film is provided, the central portion of cushion material 62 drops into the opening 61c, which makes a part of the outermost cover material 63 concave in shape. In contrast, when the film 64 is provided, the film 64 supports the central portion of the cushion material 62, which makes it possible to restrain the central portion of the cushion material 62 from dropping into the opening 61c. Therefore, the shape of the surface of the cushion material 62 can be flatten, so that it is possible to restrain unevenness from occurring on the surface of the outermost cover material 63.

### Experimental Example

A result of an experiment conducted to confirm the foregoing effects will be described. In this experiment, as shown in FIGS. 4A, 4B, when the reference position of the switch movable knob 13 is shifted toward the surface side of the instrument panel IP, the occurrence state of unevenness on the surface of the instrument panel IP was visually checked in both of the case where the film was not provided and the case where the film 64 was provided. Furthermore, this experiment was conducted on each of silicon-based cushion materials 62 with a thickness dimension of 2.0 mm and hardness C33 and hardness C10.

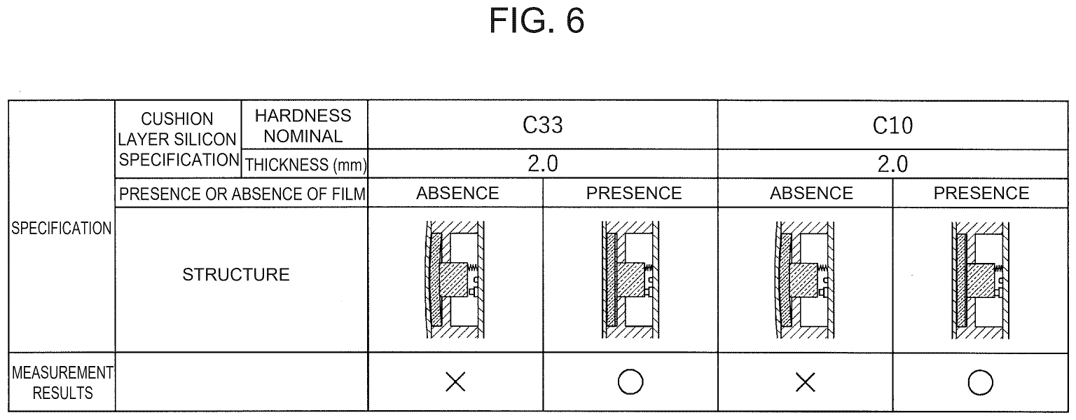

FIG. 6 is a diagram showing shows a result of this experiment. As is clear from FIG. 6, when no film was provided, relatively large unevenness occurred on the surface of the instrument panel IP regardless of the hardness of the cushion material 62. In contrast, when the film 64 was provided, no unevenness occurred on the surface of the instrument panel IP regardless of the hardness of the cushion material 62. This confirmed the foregoing effects.

### Another Embodiment

The present disclosure is not limited to the embodiment described above, and all modifications and applications within the scope of the claims and within a range equivalent thereto are possible.

For example, the embodiment has been described by applying the present disclosure to a configuration in which a plurality of light-transmitting switches 1 to 5 is incorporated in an instrument panel IP. The present disclosure is not limited to this style, and can also be applied to light-transmitting switches that are incorporated in a center console, an interior material of a door or the like. Furthermore, in the embodiment described above, the arrangement style of the light-transmitting switches 1 to 5 is set such that the push-in direction is set to a horizontal direction, but the present disclosure can also be applied to light-transmitting switches having the arrangement style being set such that the push-in direction is set to a vertical direction.

In the embodiment described above, the film 64 is interposed between the cushion material 62 and the partition panel 61b and between the cushion material 62 and the tip surface of the switch movable knob 13. Instead of or in addition to this style, the present disclosure may interpose a film between the outermost cover material 63 (more specifically, the decorative layer 17) and the cushion material 62.

In the embodiment described above, the state of each of the light-transmitting switches 1 to 5 is switched between the light-up state and the light-off state. However, the present disclosure is not limited to this style, and the state of each of the light-transmitting switches 1 to 5 may be switched between a light-up state and a light-dimming state (a light-dimming state in which the amount of transmitted light is less than that in the light-up state). Furthermore, the state of the light-transmitting switches 1 to 5 may be switched among the light-up state, the light-off state, and the light-dimming state.

The present disclosure is applicable to a light-transmitting switch incorporated in an instrument panel or the like.

What is claimed is:

1. A vehicle switch device comprising a base material, a switch member that is movable by receiving push-in operation force, a cushion material having translucency and elasticity that is disposed on a surface side of the switch member, and an outermost cover material that is disposed across a surface side of the base material and a surface side of the cushion material, wherein a film is interposed in at least one of gaps defined among the switch member, the cushion material, and the outermost cover material.

2. The vehicle switch device according to claim 1, wherein:
the base material includes a plate material disposed at a position set back from the outermost cover material, the plate material being provided with an opening through which a tip portion of the switch member is disposed;
the cushion material is disposed between the plate material and the outermost cover material; and
the film is interposed between the plate material and the cushion material, the film being in contact with an entire surface of the cushion material that faces the plate material.

3. The vehicle switch device according to claim 1, wherein the film is made of resin, and has a thickness dimension of 30 μm to 100 μm.

4. The vehicle switch device according to claim 3, wherein the film is made of a material having following physical properties:
tensile strength in a machine direction being in a range from 200 MPa to 240 MPa;
tensile strength in a direction perpendicular to the machine direction being in a range from 220 MPa to 260 MPa;
tensile elongation in the machine direction being in a range from 190% to 230%;
tensile elongation in the direction perpendicular to the machine direction being in a range from 130% to 160%;
an Fs value in the machine direction being in a range from 105 MPa to 130 MPa;
an Fs value in the direction perpendicular to the machine direction being in a range from 100 MPa to 120 MPa;
tensile elasticity in the machine direction being in a range from 3.5 GPa to 4.2 GPa; and
tensile elasticity in the direction perpendicular to the machine direction being in a range from 3.8 GPa to 4.5 GPa.
